(19) United States
(12) Patent Application Publication
(10) Pub. No.: US 2020/0385086 A1
(43) Pub. Date: Dec. 10, 2020

(54) Willie's Crancks

(71) Applicant: William Arias, miami, FL (US)

(72) Inventor: William Arias, miami, FL (US)

(21) Appl. No.: 16/297,834

(22) Filed: Mar. 11, 2019

(51) Int. Cl. B62M 3/00; B62M 1/36

(52) U.S. Cl. CPC B62M 3/003; B62M 1/36

(57) ABSTRACT

A modified crank arm with an elevated point of leverage and angle of support in relation to the crank arm is disclosed. When the point of leverage in the bicycle pedaling motion is increased, crankset rotation can be done with less physical effort of the cyclist and more bicycle speed is produced by the perpetual motion.

### CROSS-REFERENCE TO RELATED APPLICATION

Not applicable.

### TECHNICAL FIELD

The present invention relates generally to bicycles. More particularly, the present invention relates to bicycle crank arms.

### BACKGROUND

A bicycle crankset is an integral component of a bicycle drivetrain system that converts the motion from a bicycle rider's legs into rotational motion used to dive the chain, which in turn drives the rear bicycle wheel. A traditional crankset consists of one or more sprockets (i.e. chainring or chainwheels) which are attached to the crank and the crank arms. Standard cranksets are designed based the rudimentary principle of leverage. The crank arms are traditionally mounted to either side of the crankset at 180 degrees to each other and are connected by an axle. The crank arms are attached to the pedals which is the part of the bicycle that connects the rider to the crankset, thereby driving the momentum of the bicycle.

Bicycle crank arms can vary in length to accommodate different sized riders and different types of cycling. Crank arms can also be made from a range of materials, including steel, aluminum and carbon fiber. A key consideration when upgrading or replacing crank arms or cranksets is the crank length. Crank length is measured from the center of the pedal spindle to the center of the bottom bracket spindle or axle. The larger bicycle component manufacturers typically offer crank lengths for adult riders from 165 mm to 180 mm long in 2.5 mm increments, with 170 mm cranks being the most common size. Historically, bicycle riders have typically chosen proportionally shorter cranks for higher cadence cycling such as criterium and track racing, while riders have chosen proportionally longer cranks for lower cadence cycling such as time trial racing and mountain biking. However, the evolution of very low rider torso positions to reduce aerodynamic drag for time trial racing and triathlon cycling can also affect crank selection for such events. Some have suggested that proportionally shorter cranks may have a slight advantage for a rider with a very low torso position and an acute hip angle, especially as the rider pedals near the top-dead-center position of the pedal stroke.

Crank arms, which are traditionally straight, directly impact the pedal stroke and pedal force. Pedal force effectiveness in cycling is usually measured by the ratio of force perpendicular to the crank (effective force) and total force applied to the pedal (resultant force). Pedal force effectiveness is traditionally increased at higher power output and reduced at higher pedaling cadences. Attempts have been made, although unsuccessfully, to increase and/or maximize pedaling efficiency through the crank. Thease various improvements to the crankset or crank have been introduced through tandem cranksets, freewheeling cranksets, independent crank arms, and bent or curved crank arms.

For example, U.S. Pat. No. 9,469,371 B2 which generally discloses a crankset having a drive-side crank arm that is bent inwardly toward the axle assembly. While the '371 patent does disclose a crank arm that is bent inwardly, it does not disclose a bent crank arm, it does not address the challenges known in the art such as dead points and leverage.

Another variant of the traditional crank arm can be seen in disclosures such as U.S. Pat. No. 8,689,645 B2, which generally discloses a bicycle crank arm that bends slightly based on the pedaling force of the bicycle rider. As with the '371 patent, this disclosure fails to address the known challenges in the art such as dead points and leverage.

As can be seen, various attempts have been made to solve the problems which may be found in the related art but have been unsuccessful. Therefore, a need exists for a more effective crank arm that addresses the issue of dead points while simultaneously increasing the pedaling leverage of the bicycle rider.

### SUMMARY OF THE INVENTION

It is to be understood that in the present disclosure, all embodiments are provided as illustrative and non-limiting representatives of many possible embodiments. In addition, the terms “is,” “can,” “will,” and the like are used as synonyms for and interchangeable with terms such as “may,” “may provide for,” and “it is contemplated that the present invention may” and so forth.

Furthermore, all elements listed by name, such as crank, crank arm, crank set, are herein meant to include or encompass all equivalents for such elements. Such equivalents are contemplated for each element named in its particular herein.

For purposes of summarizing, certain aspects, advantages and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention relates to a sound wave cancelling suppressor for firearms that overcomes the deficiencies of the prior art. The general purpose of the invention, which will be described subsequently in greater detail, is to increase the efficiency of a bicycle crankset.

The features of the invention which are believed to be novel are particularly pointed out and distinctly claimed in the concluding portion of the specification. By way of non-limited example, the present invention provides a novel solution to increase the efficiency of a bicycle crankset. These and other features, aspects, and advantages of the present invention will become better understood with reference to the following drawings and detailed description.

The present invention addresses the lack of pedaling leverage and increased pedaling power. By modifying the crank arm's point of leverage and angle of support in relation to the crank arm, the cyclist will experience increased pedaling power while simultaneously killing the dead point. When the point of leverage in the bicycle pedaling motion is increased, crankset rotation can be done with less physical effort of the cyclist and more bicycle speed is produced by the perpetual motion.

The present invention provides for a modified crank arm that has a higher threaded pedal hole than traditional crank arms. In a preferred embodiment of the present invention, one modified crank arm is attached to the front side of a sprocket while the paired modified crank arm is attached to the back side of the sprocket. In some embodiments, the modified crank arms are connected to one another through an axle.

In a preferred embodiment of the present invention, the end point of the crank arm curves upward at an angle of approximately 10 degrees from the center of the crank arm, allowing for a higher point of leverage and a higher angle of support in relation to the center of the crank arm. In another preferred embodiment of the present invention, the length of a crank arm does not impact the angle degree of upward or downward curvature of bending of end point the crank arm.

It is also contemplated that, in certain embodiments, the higher point of leverage and higher angle of support has two main advantages over the prior art. The first is by killing the dead point effect or dead center effect, which the position where the angular velocity of the crank axel equals zero and the crank power equals zero thereby negating or eliminating the pedal force. Second, by decreasing the level of pedal effort required for each axel rotation.

### BRIEF DESCRIPTION OF THE DRAWINGS

These and other features, aspects and advantages of the present invention will become better understood with regard to the following description, appended claims, and accompanying figures where:

FIG. 1 shows a front view of a modified crankset assembly in accordance with an embodiment of the present invention.

FIG. 2 shows an illustrative front view of a modified crankset assembly in accordance with an embodiment of the present invention.

FIG. 3 shows a perspective detached view of a modified crankset assembly in accordance with an embodiment of the present invention.

FIG. 4 shows an angled front view of a modified crankset assembly in accordance with an embodiment of the present invention.

### DETAILED DESCRIPTION OF THE INVENTION

The present invention overcomes the limitations of the prior art by providing a new and more effective crank arm.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are reused to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well known features, elements or techniques may not be shown in detail in order not to obscure the embodiments.

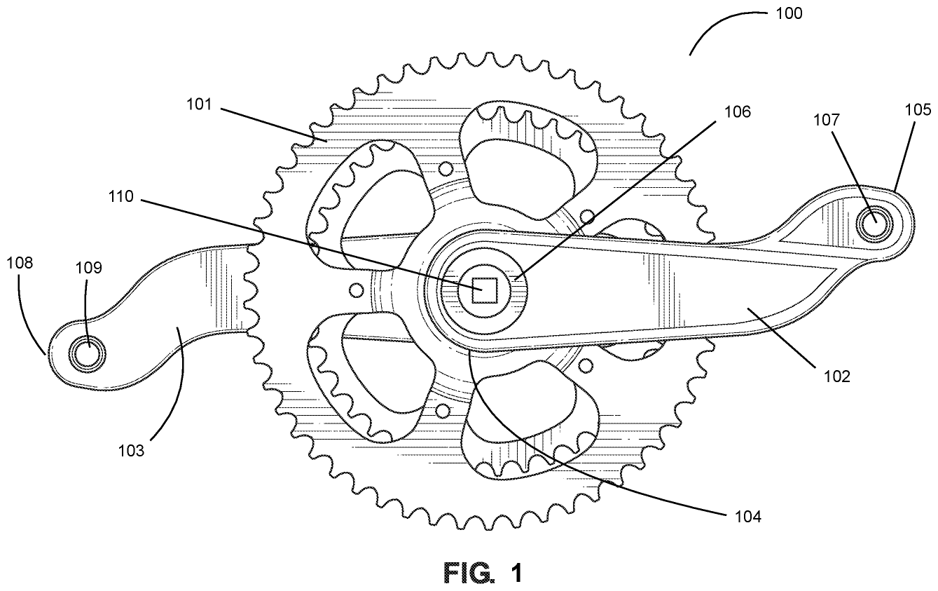

Turning attention to FIG. 1, a front view of a modified crankset assembly 100 in accordance with an embodiment of the present invention is shown. The crankset assembly 100 comprises of a sprocket 101 a forward-facing modified crank arm 102 and a rear facing modified crank arm 103. A viewer may perceive that the forward-facing modified crank arm 102 has an elongated body with a first end 104 a second end 105 an axel hole opening 106 at the first end 106 and a threaded pedal hole 107 at the second end 105. The rear facing modified crank arm 103 also has an elongated body with a first end (not shown) a first end 108 an axel hole opening (not shown) at the second end (not shown) and a threaded pedal hole 109 at the second end 108. The forward-facing modified crank arm 102 and the rear facing modified crank arm 103 are connected by an axel connector 110 which runs through the center of the sprocket 101 thereby connecting the entire crankset assembly 100.

In the embodiment depicted, a viewer may perceive that the second end 105 of the forward-facing modified crank arm 102 is bent upward from the centerline axis of the elongated body forward facing modified crank arm 102. A viewer may also perceive that the second end 108 of the rear facing modified crank arm 103 is bent upward from the centerline axis of the elongated body of the rear facing modified crank arm 104.

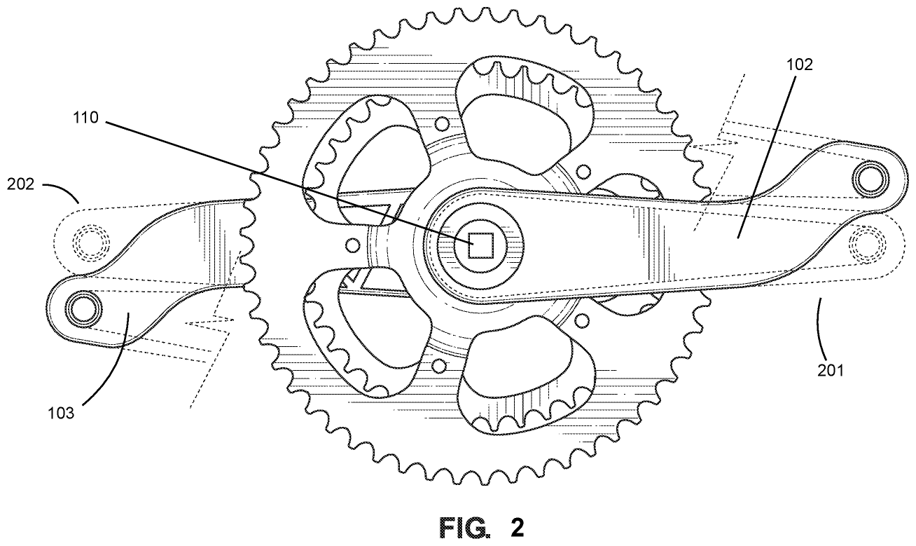

In FIG. 2 an illustrative front view of a modified crankset assembly in accordance with an embodiment of the present invention is shown. A viewer may perceive the directional relation of the forward-facing modified crank arm 102 and the rear facing modified crank arm 103 in relation to the position and directional relation of a standard forward facing crank arm 201 and standard rear facing crank arm 202.

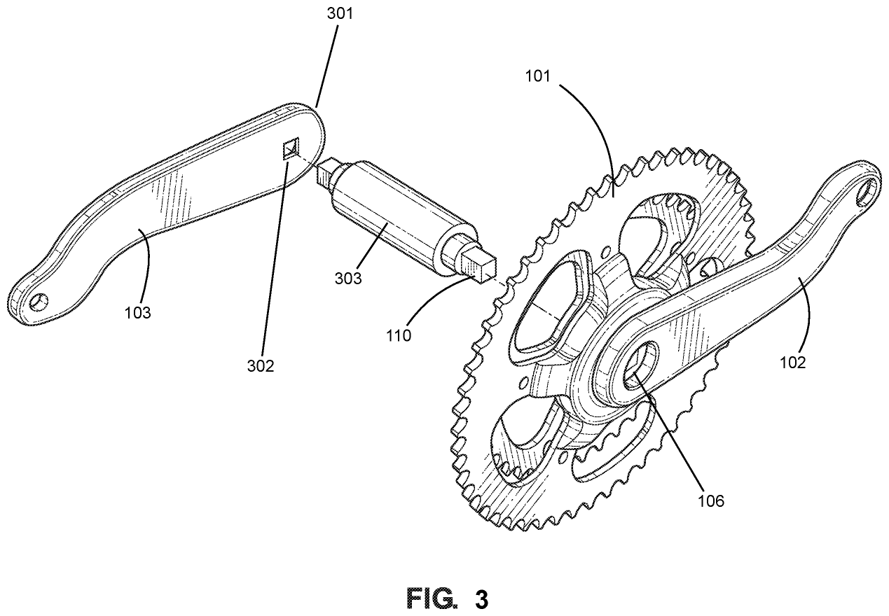

In FIG. 3 a perspective detached view of a modified crankset assembly 100 in accordance with an embodiment of the present invention is shown. In the embodiment depicted, a viewer may perceive that the axel 303 is removably connected to the axel hole opening 303 of the rear member 301 of the rear facing modified crank arm 103 and to the axel hole opening 106 of the forward facing modified crank arm 102.

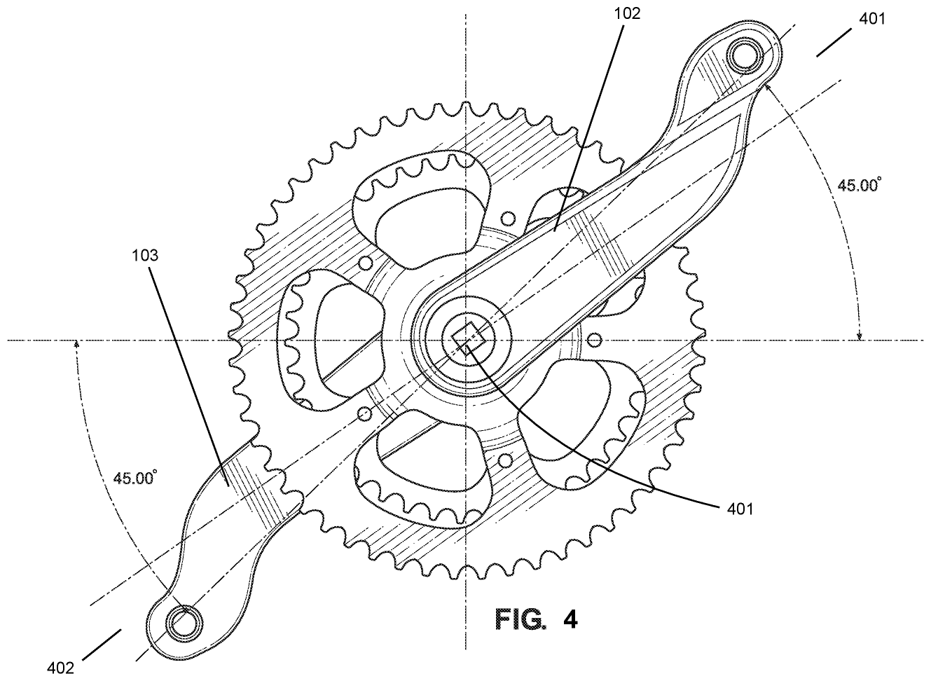

FIG. 4 shows an angled front view of a modified crankset assembly 100 in accordance with an embodiment of the present invention. In the embodiment depicted, a viewer may perceive that the centerline axis 401 of the threaded pedal hole 107 of forward-facing modified crank arm 102 is approximately 10 degrees higher than the centerline axis of the axel hole opening 106 of the forward-facing modified crank arm 102. A viewer may also perceive that the centerline axis 402 of the threaded pedal hole 109 of the rear facing modified crank arm 103 is approximately 10 degrees lower than the centerline axis of the axel hole opening 302 (not shown) of the rear facing modified crank arm 103.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations were at least some of such features and/or steps are mutually exclusive. Each feature disclosed in the specification, including the claims, abstract and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the present invention has been disclosed in connection with a number of embodiments shown and described in detail, various modifications should be readily apparent to those of skill in the art.

What is claimed is:

1. A modified bicycle crank arm comprising:
an elongated body having a first end member and a second end member;
an axle hole opening extending through the elongated body at center of the first end member; and
a threaded pedal hole opening extending through the elongated body at the center of the second end member whereby the second end member is bent.

2. The modified bicycle crank arm of claim 1 wherein the centerline axis of the threaded pedal hole opening is at least 10 degrees off center of the centerline axis of the axel hole opening.

3. The modified bicycle crank arm of claim 1 where in the second end member is bent upwards at least 10 degrees off center of the centerline axis of the axel hole opening or bent downwards at least 10 degrees off center of the centerline axis of the axel hole opening.
